(19) United States
(12) Patent Application Publication
(10) Pub. No.: US 2025/0317023 A1
(43) Pub. Date: Oct. 9, 2025

(54) RESOLVER AND ROTOR BEARING SUPPORT SYSTEM

(71) Applicant: Ford Global Technologies, LLC, Dearborn, MI (US)

(72) Inventors: Ethan Filip, Indian Trail, NC (US); Jeremy Ikerd, Eastpointe, MI (US); Singar Rathnam, Farmington Hills, MI (US)

(21) Appl. No.: 18/627,262

(22) Filed: Apr. 4, 2024

(51) Int. Cl. H02K 5/04; H02K 7/00; H02K 11/21; H02K 15/00

(52) U.S. Cl. CPC H02K 5/04; H02K 7/003; H02K 11/21; H02K 15/00

(57) ABSTRACT

Systems and methods for integrating a resolver stator and a bearing support for a rotor bearing are described. The system may electrically isolate the rotor bearing from electrically conductive materials so that arcing of electric power at rotor bearings may be addressed. In one example, the resolver stator and the bearing support may be over molded with plastic.

### FIELD

The present description relates to methods and a system for constructing a rotating electric machine with electric isolation. The methods and systems may be particularly useful for electric vehicles.

### BACKGROUND AND SUMMARY

An electric motor may include a rotor that rotates within a stator of the electric machine. The rotor may include a shaft that is supported via bearings. Electrical noise may be conducted from the shaft and through the bearings to a housing of the electric motor. If a voltage across the bearings exceeds a threshold voltage, arcing may occur within the bearings. The arcing may be less than desirable since it may lead to pitting and degradation of the bearings. Therefore, it may be desirable to provide a way of reducing a possibility of arcing within the bearings.

### BRIEF DESCRIPTION OF THE DRAWINGS

The advantages described herein will be more fully understood by reading an example of an embodiment, referred to herein as the Detailed Description, when taken alone or with reference to the drawings, where:

FIG. 1 is a schematic view of an example electric vehicle;

FIG. 2 is a schematic view of an example resolver stator;

FIG. 3 is a schematic view of an example integrated resolver stator and rotor bearing support according to the present description;

FIG. 4 is a cut-away view of an example integrated resolver stator and rotor bearing support;

FIG. 5 is a cut-away perspective view of an example integrated resolver stator and rotor bearing support; and

FIG. 6 is a flowchart of an example method for constructing an example integrated resolver stator and rotor bearing support.

### DETAILED DESCRIPTION

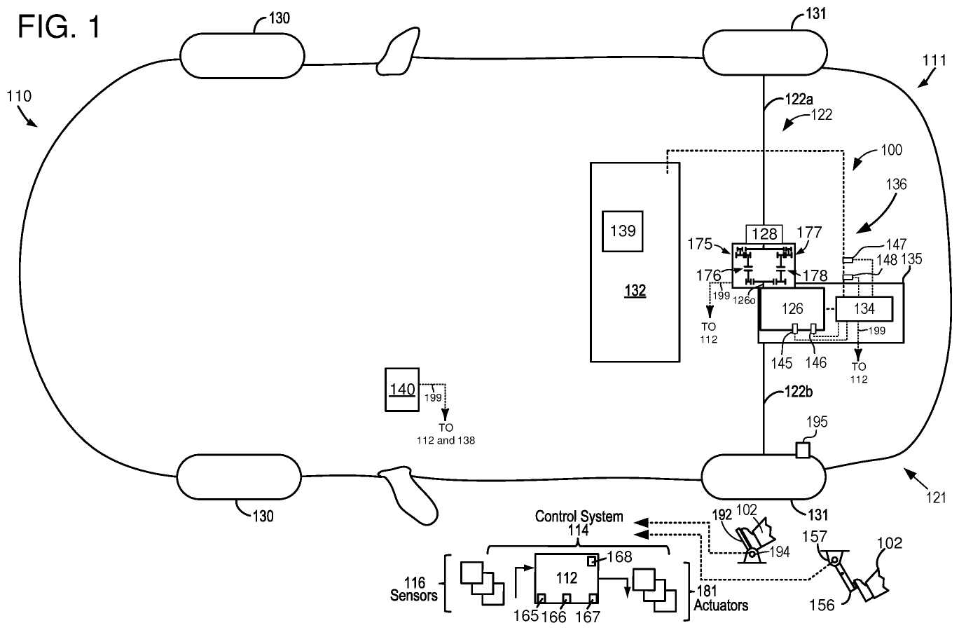

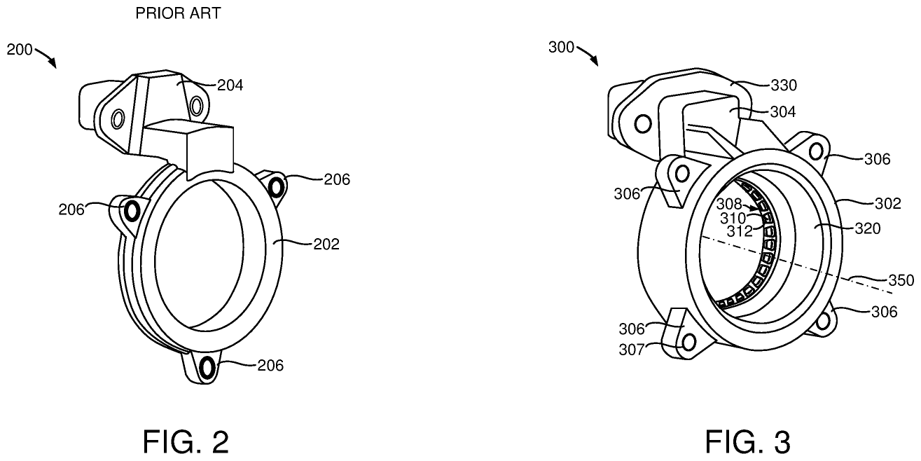

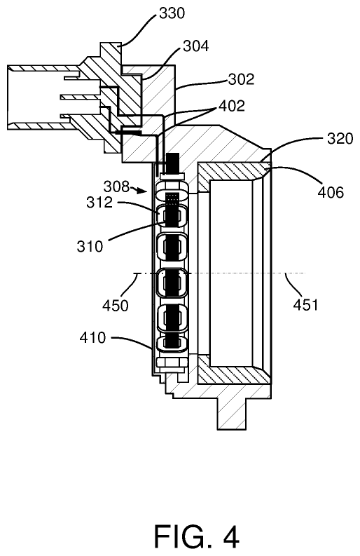

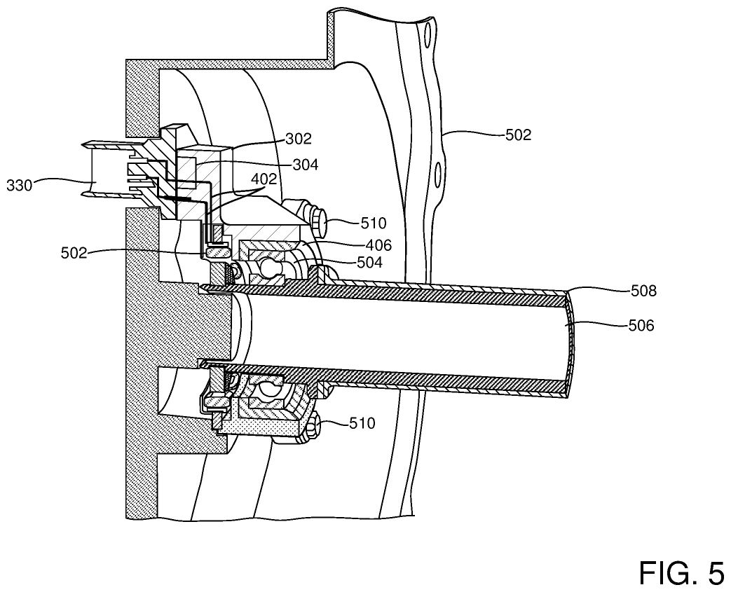

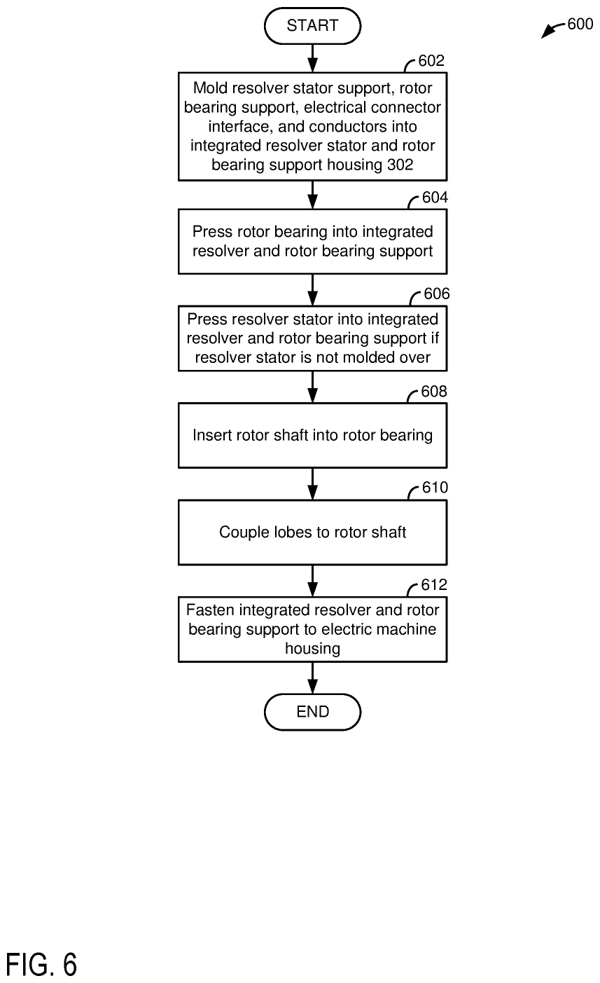

The present description is related to reducing degradation, complexity, and financial expense of an electric machine. The electric machine may be a traction motor that supplies propulsive effort for a vehicle. The vehicle may be an electric vehicle or a hybrid vehicle. The electric machine may include a resolver comprising a resolver stator and resolver lobes, a rotor, and a housing that supports the resolver and a rotor bearing. In one example, the vehicle may be an electric vehicle as shown in FIG. 1. The vehicle may include an integrated housing that is configured to support a resolver stator and a rotor bearing as shown in FIG. 2 rather than a resolver stator support as shown in FIG. 2. Cut-away views of the integrated housing are shown in FIGS. 4 and 5. A method for constructing a housing to support a resolver stator and rotor bearing is shown in FIG. 6.

An electric vehicle or hybrid vehicle may include an electric machine to provide propulsive effort for the vehicle. The electric machine may include a stator and a rotor. The rotor may rotate within the stator and the rotor may be supported via bearings. The bearings may be of metallic construction such that the bearings may allow electric power (e.g., noise) that is generated via changes in temperature, transistor switching, etc. to flow through the bearings. Because of this, it may be desirable to electrically isolate (e.g., prevent or significantly reduce electric power flow from one device to another device) the bearings from the electric machine housing that supports the bearings. A position of the rotor may also be monitored via a resolver so that electric current may be supplied to the electric machine's stator windings at prescribed timings that are based on the rotor position. The resolver and the bearings may be proximate to each other and since both the resolver and the bearings interface with the rotor's shaft, it may be desirable for the resolver and the bearing to be concentrically positioned. However, it may be difficult to fasten the resolver stator and the bearing to the electric machine housing such that the resolver stator is concentric with the bearing and such that the center of the resolver and the center of the bearing are not radially offset from each other. A resolver stator that is concentric with a bearing that supports a rotor shaft may allow smooth rotation of the rotor shaft.

The inventors herein have recognized the above-mentioned issues and have developed a support system, comprising: a housing comprises of an electric insulating material, the housing configured to support a resolver stator and a rotor bearing support cup, the resolver stator concentric with the rotor bearing support cup when the resolver stator and the bearing support cup are integrated with the housing.

By integrating a resolver stator and a bearing support cup into a single or sole housing that comprises an electric insulating material, the bearing is electrically isolated from transmission/gearbox/power unit housing to prevent arcing and degradation of the rotor bearing. Additionally, the housing may facilitate a bearing support cup to be positioned concentric with a resolver stator so as to permit unencumbered rotation of a rotor shaft within the bearing and the resolver stator.

The present description may provide several advantages. In particular, the approach may reduce a possibility of arcing within rotor bearings. Further, the approach may permit concentric positioning of the rotor bearing and the resolver stator so that a rotor shaft may rotate freely. Further, the approach may reduce an actual total number of fasteners to attach a rotor bearing and a resolver stator to an electric machine housing so that axial length of the electric machine may be reduced. Additionally, the approach may reduce a number of pilots on an electric machine housing so as to reduce system financial expense and stress points within the system.

The above advantages and other advantages, and features of the present description will be readily apparent from the following Detailed Description when taken alone or in connection with the accompanying drawings.

It may be understood that the summary above is provided to introduce in simplified form a selection of concepts that are further described in the detailed description. It is not meant to identify key features of the claimed subject matter, the scope of which is defined uniquely by the claims that follow the detailed description. Furthermore, the claimed subject matter is not limited to implementations that solve any disadvantages noted above or in any part of this disclosure.

FIG. 1 is a block diagram of a vehicle 121 including a powertrain or driveline 100. A front portion of vehicle 121 is indicated at 110 and a rear portion of vehicle 121 is indicated at 111. Driveline 100 includes electric machine 126. Electric machine 126 may consume or generate electrical power depending on its operating mode. Throughout the FIG. 1, mechanical connections between various components are illustrated as solid lines, whereas electrical connections between various components are illustrated as dashed lines.

Driveline 100 has a rear axle 122. In some examples, rear axle 122 may comprise two half shafts, for example first half shaft 122a, and second half shaft 122b. Driveline 100 also includes front wheels 130 and rear wheels 131. Rear wheels 131 may be driven via electric machine 126.

The rear axle 122 is coupled to electric machine 126. Rear drive unit 136 may transfer power from electric machine 126 to axle 122 resulting in rotation of rear wheels 131. Rear drive unit 136 may include a low gear 175 and a high gear 177 that are coupled to electric machine 126 via output shaft 126o of electric machine 126. Low gear 175 may be engaged via fully closing low gear clutch 176. High gear 177 may be engaged via fully closing high gear clutch 178. High gear clutch 178 and low gear clutch 176 may be opened and closed via commands received by rear drive unit 136 over network 199. Alternatively, high gear clutch 178 and low gear clutch 176 may be opened and closed via digital outputs or pulse widths provided via control system 114. Rear drive unit 136 may include differential 128 so that torque may be provided to first half shaft 122a and to second half shaft 122b. In some examples, an electrically controlled differential clutch (not shown) may be included in rear drive unit 136.

Electric machine 126 may receive electrical power from onboard electric energy storage device 132. Furthermore, electric machine 126 may provide a generator function to convert the vehicle's kinetic energy into electrical energy, where the electrical energy may be stored at electric energy storage device 132 for later use by electric machine 126. An inverter 134 may convert alternating current generated by electric machine 126 to direct current for storage at the electric energy storage device 132 and vice versa. Electric drive system 135 includes electric machine 126 and inverter 134. Electric energy storage device 132 may be a traction battery (e.g., a battery that supplies power to propel a vehicle), capacitor, inductor, or other electric energy storage device. Electric power flowing into electric drive system 135 may be monitored via current sensor 145 and voltage sensor 146. Position and speed of electric machine 126 may be monitored via position sensor 147. Torque generated by electric machine 126 may be monitored via torque sensor 148.

In some examples, electric energy storage device 132 may be configured to store electrical energy that may be supplied to other electrical loads residing on-board the vehicle (other than the motor), including cabin heating and air conditioning, engine starting, headlights, cabin audio and video systems, etc.

Control system 114 may communicate with electric machine 126, electric energy storage device 132, etc. Control system 114 may receive sensory feedback information from electric drive system 135 and electric energy storage device 132, etc. Further, control system 114 may send control signals to electric drive system 135 and electric energy storage device 132, etc., responsive to this sensory feedback. Control system 114 may receive an indication of an operator requested output of the vehicle propulsion system from a human operator 102, or an autonomous controller. For example, control system 114 may receive sensory feedback from pedal position sensor 194 which communicates with pedal 192. Pedal 192 may refer schematically to a driver demand pedal. Similarly, control system 114 may receive an indication of an operator requested vehicle slowing via a human operator 102, or an autonomous controller. For example, control system 114 may receive sensory feedback from pedal position sensor 157 which communicates with caliper control pedal 156.

Electric energy storage device 132 may periodically receive electrical energy from a power source such as a stationary power grid (not shown) residing external to the vehicle (e.g., not part of the vehicle). As a non-limiting example, driveline 100 may be configured as a plug-in electric vehicle (EV), whereby electrical energy may be supplied to electric energy storage device 132 via the power grid (not shown).

Electric energy storage device 132 includes an electric energy storage device controller 139. Electric energy storage device controller 139 may provide charge balancing between energy storage element (e.g., battery cells) and communication with other vehicle controllers (e.g., controller 112).

One or more wheel speed sensors (WSS) 195 may be coupled to one or more wheels of driveline 100. The wheel speed sensors may detect rotational speed of each wheel. Such an example of a WSS may include a permanent magnet type of sensor.

Controller 112 may comprise a portion of a control system 114. In some examples, controller 112 may be a single controller of the vehicle. Control system 114 is shown receiving information from a plurality of sensors 116 (various examples of which are described herein) and sending control signals to a plurality of actuators 181 (various examples of which are described herein). As one example, sensors 116 may include tire pressure sensor(s) (not shown), wheel speed sensor(s) 195, etc. In some examples, sensors associated with electric machine 126, wheel speed sensor 195, etc., may communicate information to controller 112, regarding various states of electric machine operation. Controller 112 includes non-transitory (e.g., read exclusive memory) 165, random access memory 166, digital inputs/outputs 168, and a microcontroller 167. Infotainment system 140 (e.g., a human/machine interface) may receive input data from human 102 and may display messages and data to human 102. Infotainment system 140 may communicate to controller 112 and power distribution module 138 via network 199 (e.g., a controller area network (CAN) or an Ethernet network). Infotainment system 140 may operate in some modes as a human/machine interface.

Referring now to FIG. 2, a schematic view of an example prior art resolver 200 is shown. Resolver 200 includes a stator 202 that may be fastened to a housing of an electric machine via mounting flanges 206. Resolver 200 includes an electrical connector 204 so that it may send a position of a rotor shaft to a controller (not shown). Stator 202 may include a steel stamping and windings wrapped around the steel stamping (not shown).

Referring now to FIG. 3, a perspective view of an example integrated resolver stator and rotor bearing support 300 according to the present description is shown. Integrated resolver stator and rotor bearing support 300 includes a resolver stator 308 comprising steel stamping 310 and copper windings 312 that are wrapped around the steel stamping 310. Further, integrated resolver stator and rotor bearing support includes an electrical connector interface 304 (e.g., a receptacle or plug), mounting flanges 306, and rotor bearing support 320 within integrated resolver stator and rotor bearing support housing 302. Electric connector interface 304 and integrated resolver stator and rotor bearing support housing 302 may be of unitary and/or seamless construction. Mounting flanges 306 may include metallic sleeves 307. Integrated resolver stator and rotor bearing support 300 includes a resolver stator 308 is shown interfacing with electrical connector 330. The resolver stator 308 and the rotor bearing support 320 are concentric with respect to centerline 350.

Integrated resolver stator and rotor bearing support 300 may be molded of an electrical insulating material such as plastic so that a rotor bearing (not shown) may be installed into integrated resolver stator and rotor bearing support 300 and be electrically isolated from the electric machine housing that the integrated resolver stator and rotor bearing support may be coupled to. The insulating materials is substantially electrically non-conductive relative to the electric current carrying members. Integrated resolver stator and rotor bearing support 300 may be fabricated via injection molding or other known processes. Integrated resolver stator and rotor bearing support 300 may be molded over (e.g., the molding medium (e.g., plastic) at least partially covers the device that is being molded over) resolver stator 308 as shown in FIG. 4. Further, the integrated resolver stator and rotor bearing support 300 may be molded over the rotor bearing support cup.

Moving on to FIG. 4, a cut-away view of 300 is shown. This cut-away view shows rotor bearing support cup 406 inserted (e.g., press fit) into and occupying a portion of a rotor bearing support 320 that is within integrated resolver stator and rotor bearing support housing 302. Centerline 451 of rotor bearing support cup 406 is aligned with centerline 450 of resolver stator 308. Further, centerline 451 and centerline 450 are aligned with the centerline 350 of the rotor bearing support 320 shown in FIG. 3. Steel stamping 310 and copper windings 312 of resolver stator 308 are annular in shape so as to allow a shaft of a rotor to rotate within resolver stator 308. Resolver stator 308 may be held in place via a retainer 410 that is press fit, or alternatively, a molded over resolver stator 308. Conductors 402 extend from resolver stator 308 to electric connector interface 304. Electrical connector interface 304 is shown mated to electrical connector 330.

Referring now to FIG. 5, cut-away perspective view of integrated resolver stator and rotor bearing support 300. In this view, integrated resolver stator and rotor bearing support 300 is shown mechanically coupled to electric machine housing 502 of electric machine 126 shown in FIG. 1. Further, rotor bearing 504 is inserted into rotor bearing support cup 406. Rotor bearing 504 supports rotor shaft 506 and rotor sleeve 508. Rotor shaft 506 supports a rotor core (not shown). Resolver lobes 510 are coupled to rotor shaft 506. Rotor shaft 506 and rotor sleeve 508 are supported via electric machine housing 502, integrated resolver stator and rotor bearing support integrated resolver stator and rotor bearing support housing 302, rotor bearing 504, and rotor bearing support cup 406. Fasteners 510 couple integrated resolver stator and rotor bearing support housing 302 to electric machine housing 502.

FIGS. 2-5 are drawn to scale, although other relative dimensions may be used. FIGS. 1-5 show example configurations with relative positioning of the various components. Unless otherwise noted, if shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

The system of FIGS. 1-5 provides for a support system, comprising: a housing comprised of an electric insulating material, the housing configured to support a resolver stator and a bearing support cup, the resolver stator concentric with the bearing support cup when the resolver stator and the bearing support cup are integrated with the housing. In a first example, the support system includes where the housing is molded over at least a portion of the resolver stator. In a second example that may include the first example, the support system includes where the resolver stator is held within the housing via a retainer. In a third example that may include one or both of the first and second examples, the support system includes where the bearing support cup comprises steel or aluminum. In a fourth example that may include one or more of the first through third examples, the support system includes where the housing is molded over the bearing support cup. In a fifth example that may include one or more of the first through fourth examples, the support system further comprises an interface for an electrical connector seamlessly integrated into the housing. In a sixth example that may include one or more of the first through fifth examples, the support system further comprises electrical conductors extending from the resolver stator to the interface.

The system of FIGS. 1-5 also provides for a support system, comprising: an electric machine housing; an electric machine rotor shaft; a housing comprised of an electric insulating material, the housing including a resolver stator and a bearing support cup, the resolver stator concentric with the rotor bearing support cup, the housing coupled to the electric machine housing. In a first example, the support system further comprises a bearing, the bearing pressed into the rotor bearing support cup. In a second example that may include the first example, the support system includes where the electric machine rotor shaft is inserted into the rotor bearing support cup. In a second example that may include the first example, the support system further comprises resolver lobes coupled to the electric machine rotor shaft. In a third example that may include one or both of the first and second examples, the support system further comprises an electrical connector receiver formed in the housing, an electrical connector coupled to the electric machine housing, the electrical connector mated to the electrical connector receiver.

Referring now to FIG. 6, a method for constructing an integrated resolver stator and rotor bearing support housing is shown. Method 600 may be performed via a human and/or automated machinery in the physical world.

At 602, method 600 molds or machines an integrated resolver stator and rotor bearing support housing. The integrated resolver stator and rotor bearing support housing may be molded, or alternatively machined, from plastic or another electrical insulating material. In some examples, the integrated resolver stator and rotor bearing support housing may be molded over a resolver stator and/or a bearing support cup as shown in FIG. 4. Further, the integrated resolver stator and rotor bearing support housing may be molded over conductors that extend from a resolver stator to an electrical connector interface as shown in FIG. 4. The integrated resolver stator and rotor bearing support housing includes and/or forms a resolver stator support and a rotor bearing support. The resolver stator support and the rotor bearing support are formed or molded such that the rotor bearing centerline and the rotor bearing support cup centerline are concentric with the resolver stator center line when the rotor bearing and resolver are supported by the integrated resolver stator support and the rotor bearing support. Additionally, where the resolver stator and the bearing support cup are not molded over, the resolver stator and the bearing support cup are installed to the integrated resolver stator and rotor bearing support. Method 600 proceeds to 604.

At 604, the rotor bearing is pressed into the rotor bearing support cup. Method 600 proceeds to 606.

At 606, the resolver stator is pressed into the integrated resolver stator support and rotor bearing support if the resolver stator is not molded over. Method 600 proceeds to 608.

At 608, method 600 inserts the electric machine rotor shaft into the rotor bearing that has been pressed into the integrated resolver stator support and rotor bearing support. Method 600 proceeds to 610.

At 610, resolver lobes are coupled to the electric machine rotor shaft. The lobes allow the rotor shaft position to be determined via the resolver stator. Method 600 proceeds to 612.

At 612, the integrated resolver stator support and rotor bearing support along with the rotor bearing are coupled to the electric machine housing. The electric machine housing supports the integrated resolver stator support and rotor bearing support, the rotor bearing, and the electric machine rotor shaft. Method 600 proceeds to exit.

Thus, method 600 manages operation of DC/DC converters so that sufficient power may be available to DC electric loads on the DC bus while compensating for DC/DC converter efficiency and output capacity. Further, method 400 provides for user input to override automatic electric power management for situations where the user may not want to reduce a distance that the vehicle has capacity to travel according to the present level of energy stored in the traction battery.

Accordingly, the method of FIG. 6 provides for a method for constructing a support for a resolver stator and a rotor bearing support cup, comprising: molding the support of an electric insulation material such the resolver stator and the rotor bearing support cup when assembled with the support are concentric about a resolver stator center line and a rotor bearing support cup centerline. In a first example, the method includes where the electric insulation material is plastic. In a second example that may include the first example, the method further comprises molding electric conductors within the support. In a third example that may include one or both of the first and second examples, the method further comprises molding an electric connector interface into the support. In a fourth example that may include one or more of the first through third examples, the method includes where the electric conductors extend from the electric connector interface to a resolver. In a fifth example that may include one or more of the first through fourth examples, the method further comprises molding the support over the resolver stator. In a sixth example that may include one or more of the first through fifth examples, the method further comprises molding the support over a bearing support cup. In a seventh example that may include one or more of the first through sixth examples, the method further comprises pressing a bearing into the rotor bearing support cup.

Note that the example construction processes included herein can be used with various electric machine system configurations. The construction processes disclosed herein may be performed via humans or machine automation. The construction processes described herein may be performed in a different order than has been described herein. One or more of the illustrated actions, operations and/or functions may be repeatedly performed depending on the particular process being used.

This concludes the description. The reading of it by those skilled in the art would bring to mind many alterations and modifications without departing from the spirit and the scope of the description. For example, electric and hybrid vehicle configurations could use the present description to advantage.

1. A support system, comprising:
a housing comprised of an electric insulating material, the housing configured to support a resolver stator and a rotor bearing support cup, the resolver stator concentric with the rotor bearing support cup when the resolver stator and the rotor bearing support cup are integrated with the housing.

2. The support system of claim 1, where the housing is molded over at least a portion of the resolver stator.

3. The support system of claim 1, where the resolver stator is held within the housing via a retainer.

4. The support system of claim 1, where the rotor bearing support cup comprises steel or aluminum.

5. The support system of claim 4, where the housing is molded over the rotor bearing support cup.

6. The support system of claim 1, further comprising an interface for an electrical connector seamlessly integrated into the housing.

7. The support system of claim 6, further comprising electrical conductors extending from the resolver stator to the interface.

8. A method for constructing a support for a resolver stator and a rotor bearing support cup, comprising:
molding the support of an electric insulation material such the resolver stator and the rotor bearing support cup when assembled with the support are concentric about a resolver stator center line and a rotor bearing support cup centerline.

9. The method of claim 8, where the electric insulation material is plastic.

10. The method of claim 8, further comprising molding electric conductors within the support.

11. The method of claim 10, further comprising molding an electric connector interface into the support.

12. The method of claim 11, where the electric conductors extend from the electric connector interface to a resolver.

13. The method of claim 12, further comprising molding the support over the resolver stator.

14. The method of claim 13, further comprising molding the support over a bearing support cup.

15. The method of claim 14, further comprising pressing a bearing into the rotor bearing support cup.

16. A support system, comprising:
an electric machine housing;
an electric machine rotor shaft;
a housing comprised of an electric insulating material, the housing including a resolver stator and a rotor bearing support cup, the resolver stator concentric with the rotor bearing support cup, the housing coupled to the electric machine housing.

17. The support system of claim 16, further comprising a bearing, the bearing pressed into the rotor bearing support cup.

18. The support system of claim 16, where the electric machine rotor shaft is inserted into the rotor bearing support cup.

19. The support system of claim 18, further comprising resolver lobes coupled to the electric machine rotor shaft.

20. The support system of claim 16, further comprising an electrical connector receiver formed in the housing, an electrical connector coupled to the electric machine housing, the electrical connector mated to the electrical connector receiver.
